(19) United States
(12) Patent Application Publication
(10) Pub. No.: US 2004/0183683 A1
(43) Pub. Date: Sep. 23, 2004

(54) Medical support system and medical support apparatus

(75) Inventor: Takeshi Funahashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/801,594

(22) Filed: Mar. 17, 2004

(30) Foreign Application Priority Data
Mar. 19, 2003 (JP) 2003-076472
Mar. 19, 2003 (JP) 2003-076473

(51) Int. Cl. G08B 21/02; G08B 5/22; G05B 9/02

(52) U.S. Cl. 340/573.1; 340/825.36; 235/375; 700/80; 600/300

(57) ABSTRACT

A medical support system for supporting a medical care of a patient includes: a wireless tag carried by the patient; a medical information database for storing medical information of the patient; and a medical support apparatus for communicating with the wireless tag and the medical information database. The medical support apparatus includes: a patient ID acquisition unit for obtaining a patient ID that identifies the patient from the wireless tag when the patient approached the medical support apparatus; a suitability determination unit for referring to the medical information database and determining whether or not the medical support apparatus is suitable for the patient identified by the obtained patient ID; and a warning unit for issuing a warning to the patient when the suitability determination unit determined that the medical support apparatus was unsuitable for the patient.

This patent application claims priority from Japanese patent applications Nos. 2003-076472 and 2003-076473 filed on Mar. 19, 2003, the contents of which are incorporated herein by reference.

### BACKGROUND OF THE INVENTION

1. Field of the Invention

The present invention relates to a medical support system and a medical support apparatus. More particularly, the present invention relates to a medical support system and a medical support apparatus for supporting a medical care of patients.

2. Description of the Related Art

Conventionally, a check of a patient in a clinic or hospital was done by asking the patient about his/her name directly if the patient can make a reply or by checking the name of the patient on the name tag of the patient's bed if the patient cannot make a reply.

However, in the checking method described above, misidentification of patients caused by false belief, oversight or the like, of a medical staff such as a doctor or a nurse, may occur and cause a serious medical error.

### SUMMARY OF THE INVENTION

Therefore, it is an object of the present invention to provide a medical support system and a medical support apparatus, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, a medical support system for supporting a medical care of a patient, comprises: a wireless tag carried by the patient; a medical information database operable to store medical information of the patient; and a medical support apparatus operable to communicate with said wireless tag and said medical information database. In this medical support system, the medical support apparatus includes: a patient ID acquisition unit operable to obtain a patient ID for identifying the patient from said wireless tag when the patient approached said medical support apparatus; a suitability determination unit operable to refer to said medical information database and determine whether or not said medical support apparatus is suitable for the patient identified by the patient ID thus obtained; and a warning unit operable to issue a warning to the patient when said suitability determination unit determined that said medical support apparatus was unsuitable for the patient.

The wireless tag may transmit the patient ID to said medical support apparatus using a radio wave that enables communication with said medical support apparatus only when said wireless tag approached said medical support apparatus.

The medical support apparatus may further include: a setting information extraction unit operable to extract setting information related to setting of said medical support apparatus in accordance with the patient from said medical information of the patient stored in said medical information database, when said suitability determination unit determined that said medical support apparatus was suitable for the patient; and a set unit operable to set said setting information thus extracted in said medical support apparatus.

The medical support apparatus may be a radiography apparatus, and said setting information extraction unit may extract a radiographic condition for the patient from said medical information of the patient stored in said medical information database, when said suitability determination unit determined that said medical support apparatus was suitable for the patient.

The patient ID acquisition unit may be provided on a platform of said radiography apparatus.

The medical support apparatus may further include: a setting information extraction unit operable to extract setting information related to setting of said medical support apparatus in accordance with the patient from said medical information of the patient stored in said medical information database, when said suitability determination unit determined said medical support apparatus was suitable; and a display unit operable to display said setting information thus extracted.

The medical support apparatus of the invention may be applied as a training apparatus for supporting rehabilitation, and said setting information extraction unit may extract a menu of rehabilitation of the patient from said medical information of the patient stored in said medical information database, when said suitability determination unit determined that said medical support apparatus was suitable.

According to the second aspect of the present invention, a medical support apparatus for supporting a medical care of a patient, comprises: a patient ID acquisition unit operable to obtain a patient ID for identifying the patient from a wireless tag carried by the patient when the patient approached said medical support apparatus; a suitability determination unit operable to refer to a medical information database that stores medical information of the patient and determine whether or not said medical support apparatus is suitable for the patient identified by the patient ID obtained by the patient ID acquisition unit; and a warning unit operable to issue a warning to the patient when said suitability determination unit determined that said medical support apparatus was unsuitable for the patient.

According to the third aspect of the present invention, a medical support system for supporting a medical care of a patient, comprises: a patient's wireless tag carried by the patient; a diagnosis/treatment member's wireless tag attached to a diagnosis/treatment member; a medical information database operable to store medical information of the patient; and a medical support apparatus operable to communicate with the patient's wireless tag, said diagnosis/treatment member's wireless tag and said medical information database. In this medical support system, the medical support apparatus includes: a patient ID acquisition unit operable to obtain a patient ID for identifying the patient from the patient's wireless tag when the patient approached said medical support apparatus sufficiently; a diagnosis/treatment member ID acquisition unit operable to obtain a diagnosis/treatment member ID for identifying said diagnosis/treatment member from said diagnosis/treatment member's wireless tag when said diagnosis/treatment member approached said medical support apparatus sufficiently; a diagnosis/treatment member determination unit operable to refer to said medical information database and determine whether or not said diagnosis/treatment member identified by said diagnosis/treatment member ID obtained by said diagnosis/treatment member ID acquisition unit is suitable for the patient identified by the patient ID obtained by the patient ID acquisition unit; and a warning unit operable to issue a warning to the patient when said diagnosis/treatment member determination unit determined that said diagnosis/treatment member was unsuitable.

The patient's wireless tag may transmit the patient ID to said medical support apparatus using a radio wave that enables communication with said medical support apparatus only when the patient's wireless tag approached said medical support apparatus sufficiently.

The diagnosis/treatment member's wireless tag may transmit said diagnosis/treatment member ID to said medical support apparatus using a radio wave that enables communication with said medical support apparatus only when said diagnosis/treatment member's wireless tag approached said medical support apparatus sufficiently.

The medical support system may further comprise a nurse's wireless tag held by a nurse, wherein said medical support apparatus further includes: a nurse ID acquisition unit operable to obtain a nurse ID for identifying said nurse from said nurse's wireless tag when said nurse approached said medical support apparatus sufficiently; and a nurse determination unit operable to refer to said medical information database and determine whether or not said nurse identified by said nurse ID obtained by said nurse ID acquisition unit is in charge of the patient identified by the patient ID obtained by the patient ID acquisition unit, and wherein said warning unit issues said warning in a case where said nurse is not in charge of the patient.

The nurse's wireless tag may transmit said nurse ID to said medical support apparatus using a radio waves that enables communication with said medical support apparatus only when said nurse's wireless tag approached said medical support apparatus sufficiently.

The diagnosis/treatment member may be medicine, said diagnosis/treatment member's wireless tag may be attached to a holder of said medicine, and said warning unit may issue said warning when said diagnosis/treatment member determination unit determined that said medicine was unsuitable for the patient.

The medical information database may store a dosing schedule of said medicine to the patient and a dosing history containing dates and times at which said medicine was dosed to the patient to correspond to the patient, said medical support apparatus may further include a dosing timing determination unit operable to determine whether or not a dosing timing of said medicine identified by said diagnosis/treatment member ID obtained by said diagnosis/treatment member ID acquisition unit to the patient identified by the patient ID obtained by the patient ID acquisition unit, based on said dosing schedule and said dosing history, and said warning unit may issue said warning to the patient when said dosing timing determination unit determined that said dosing timing was improper.

The medical support system may further comprise a medication error management database operable to store improper combinations of a disease/injury and said diagnosis/treatment member, wherein said medical support apparatus further includes a medication error determination unit operable to extract a disease/injury of the patient identified by the patient ID obtained by the patient ID acquisition unit from said medical information database and determine whether or not a combination of said disease/injury thus extracted and said diagnosis/treatment member identified by said diagnosis/treatment member ID obtained by said diagnosis/treatment member ID acquisition unit is improper by referring to said medication error management database, and wherein said warning unit issues said warning to the patient when said medication error determination unit determined said combination was improper.

According to the fourth aspect of the present invention, a medical support apparatus for supporting a medical care of a patient, comprises: a patient ID acquisition unit operable to obtain a patient ID for identifying the patient from a patient's wireless tag carried by the patient when the patient approached said medical support apparatus sufficiently; a diagnosis/treatment member ID acquisition unit operable to obtain a diagnosis/treatment member ID for identifying a diagnosis/treatment member from a diagnosis/treatment member's wireless tag attached to said diagnosis/treatment member when said diagnosis/treatment member approached said medical support apparatus sufficiently; a diagnosis/treatment member determination unit operable to refer to a medical information database that stores medical information of the patient and determine whether or not said diagnosis/treatment member identified by said diagnosis/treatment member ID thus obtained is suitable for the patient identified by the patient ID thus obtained; and a warning unit operable to issue a warning to the patient when said diagnosis/treatment member determination unit determined that said diagnosis/treatment member was unsuitable for the patient.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 illustrates an exemplary configuration of a medical support system according to the first embodiment of the present invention.

FIG. 2 is an exemplary functional diagram of a medical support apparatus according to the first embodiment.

FIG. 3 is a flowchart of an exemplary operation of the medical support apparatus according to the first embodiment.

FIG. 4 shows the first specific example of the medical support apparatus according to the first embodiment.

FIG. 5 shows the second specific example of the medical support apparatus according to the first embodiment.

FIG. 6 illustrates an exemplary configuration of a medical support system according to the second embodiment of the present invention.

FIG. 7 illustrates an exemplary configuration of the medical support system according to the second embodiment.

FIG. 8 is an exemplary functional diagram of a medical support apparatus according to the second embodiment.

FIGS. 9 and 10 are flowcharts of an exemplary operation of the medical support apparatus according to the second embodiment.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

(Embodiment 1)

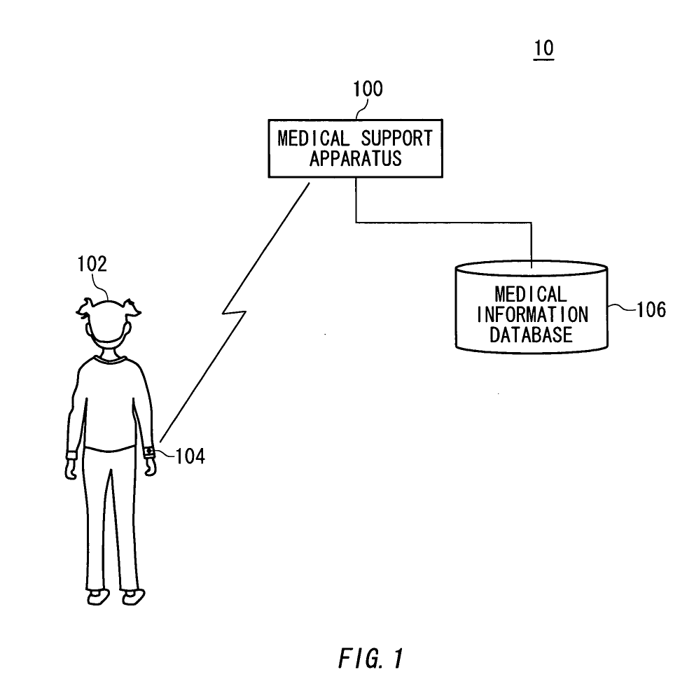

FIG. 1 illustrates an exemplary configuration of a medical support system 10 according to the first embodiment of the present invention. The medical support system 10 aims to determine, when a patient 102 approached a medical support apparatus 100, the patient 102 is to undergo a medical treatment by the medical support apparatus 102, thereby preventing a medical error caused by misidentification of patients. The medical support apparatus 100 may be a radiography apparatus, a radiotherapy apparatus, a training apparatus for supporting rehabilitation of a patient, or the like.

The medical support system 10 includes the medical support apparatus 100 for supporting a medical care of the patient 102, a wireless IC tag 104 such as a wireless IC chip carried by the patient 102, and a medical information database 106 that stores medical information of patients. The medical support apparatus 100 communicates with the wireless tag 104 and the medical information database 106 to receive data therefrom and transmit data thereto.

The wireless tag 104 holds a patient ID for identifying the patient 102 in a memory incorporated therein and transmits the patient ID to the medical support apparatus 100 using a relatively weak radio wave that enables communication with the medical support apparatus 100 only when the wireless tag 104 approached the medical support apparatus 100. The medical support apparatus 100 determines that the patient 102 approached the apparatus 100 from the fact that the apparatus 100 obtained the patient ID.

The medical support apparatus 100 obtains the patient ID from the wireless tag 104 of the patient 102 who is near the medical support apparatus 100 and then refers to medical information of the patient 102 stored in the medical information database 106 based on the patient ID thus obtained. The medical information database 106 stores the diagnosis of the patient 102 such as the name of disease or injury, and/or a treatment program such as a schedule of examinations or rehabilitation as the medical information. The medical support apparatus 100 refers to that kind of information and determines whether or not the patient 102 is to use the medical support apparatus 100. Based on the determination result, the medical support apparatus 100 issues a warning to the patient 102, displays information for the patient 102, sets the medical support apparatus 100, for example.

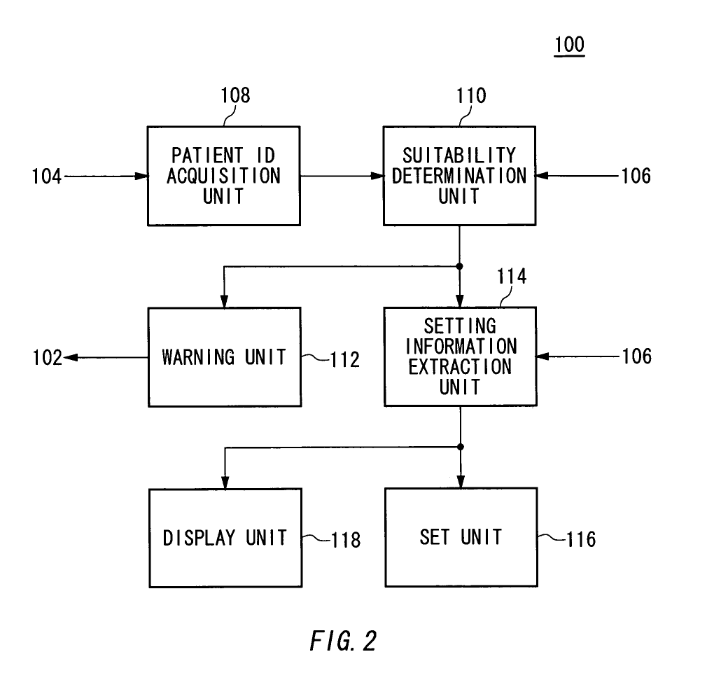

FIG. 2 is an exemplary functional diagram of the medical support apparatus 100 of the present embodiment. The medical support apparatus 100 includes a patient ID acquisition unit 108 that obtains the patient ID for identifying the patient 102 from the wireless tag 104 carried by the patient 102; a suitability determination unit 110 that determines whether or not the medical support apparatus 100 is suitable for the patient 102 identified by the patient ID thus obtained; a warning unit 112 that issues a warning to the patient 102 in a case where the medical support apparatus 100 is not suitable for the patient 102; a setting information extraction unit 114 that extracts setting information related to setting of the medical support apparatus 100 from the medical information database 106 in accordance with the patient 102; a set unit 106 that sets the extracted setting information in the medical support apparatus 100; and a display unit 118 that displays the extracted setting information.

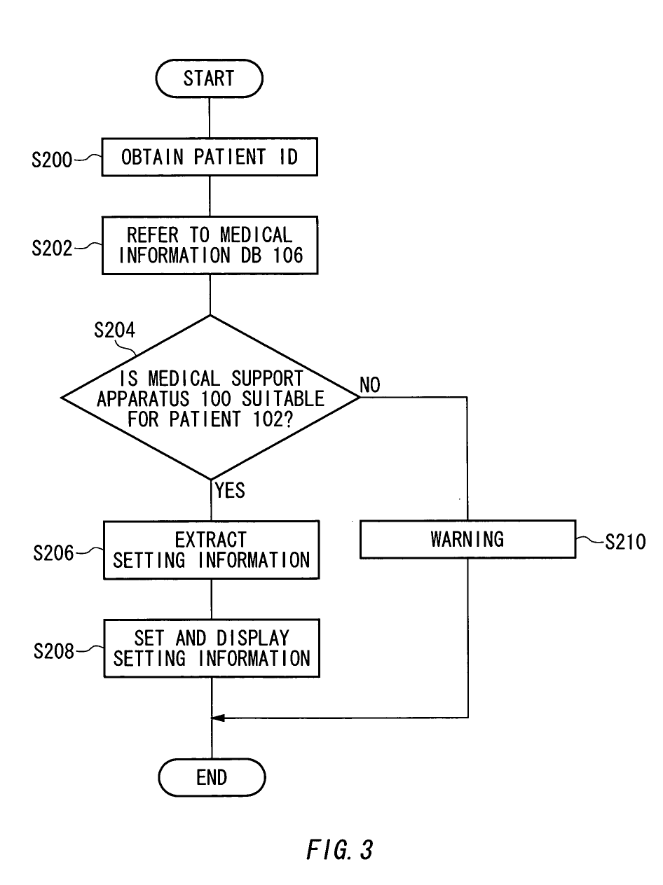

FIG. 3 is a flowchart of an exemplary operation of the medical support apparatus 100 according to the present embodiment. When the patient 102 approached the medical support apparatus 100, the patient ID acquisition unit 108 obtains the patient ID transmitted from the wireless tag 104 carried by the patient 102 (Step S200). The suitability determination unit 110 then refers to the medical information database 106 (Step S202), and determines whether or not the medical support apparatus 100 is suitable for the patient 102 identified by the patient ID obtained by the patient ID acquisition unit 108 (Step S304).

When the suitability determination unit 110 determined that the medical support apparatus 100 was suitable (Step S204-Y), the setting information extraction unit 114 extracts setting information of the medical support apparatus 100 in accordance with the patient 102 from the medical information of the patient 102 stored in the medical information database 106 (Step S206). Then, the set unit 116 sets the medical support apparatus 100 in accordance with the setting information thus extracted, and the display unit 118 displays that setting information to the patient 102 or doctor (Step S208).

When the suitability determination unit 110 determined that the medical support apparatus 100 was unsuitable for the patient 102 (Step S204-N), the medical support apparatus 100 issues a warning by sounds or the like to the patient 102 or doctor, thereby notifying the patient 102 or doctor of misidentification of patient (Step S210). In this manner, it is possible to prevent misidentification of patients by monitoring whether or not the patient 102 who approached the medical support apparatus 100 is to undergo a medical treatment by the medical support apparatus 100 based on information in the medical record of the patient 102, thus preventing a medical error.

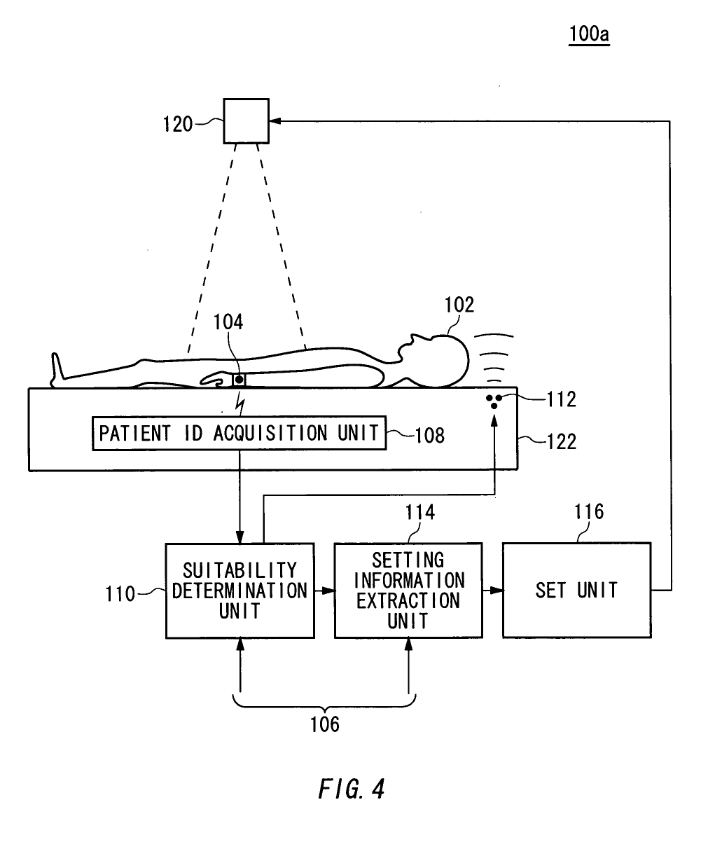

FIG. 4 shows the first specific example of the medical support apparatus 100 according to the present embodiment. The medical support apparatus 100 of this example is a radiography apparatus 100a that obtains a radiograph of the patient 102 on a platform 122 by using radiation radiated from a radiation source 120. The platform 122 is a bed for CT (computed tomography) scan or a platform for a chest X-ray machine, for example.

The patient ID acquisition unit 108 is provided on the platform 122 and obtains the patient ID from the wireless tag 104 of the patient 102 who approached the platform 122. Because the patient 102 always approaches the platform 122 when the radiograph of the patient 102 is going to be taken, it is possible to obtain the patient ID of the patient 102 without fail by providing the patient ID acquisition unit 108 on the platform 122. In addition, the warning unit 112 such as a speaker may be provided in the platform 122 to issue a warning sound to the patient 102 or doctor.

When the suitability determination unit 110 confirmed that the patient 102 was a patient of whom a radiograph was to be taken by the radiography apparatus 100a, the setting information extraction unit 114 extracts a radiographic condition for the patient 102 from the medical information database 106. The radiographic condition includes the intensity of radiation radiated from the radiation source 120 and/or a grid ratio, for example. The medical information database 106 stores the previous radiographic condition for the patient 102 as the medical information of the patient 102. The setting information extraction unit 114 extracts the previous radiographic condition for the patient 102 from the medical information database 106. The set unit 116 then sets the intensity of radiation from the radiation source 120 or the like, based on the radiographic condition thus extracted. Finally, the radiography apparatus 100a takes the radiograph of the patient 102.

In this manner, by automatically extracting the radiographic condition for the patient 102 and setting the medical support apparatus 100 in accordance with the extracted radiographic condition, it is possible not only to prevent misidentification of patients but also to take a radiograph of the patient 102 with an appropriate radiographic condition. In addition, since the radiograph can be taken with the same condition as the previous condition, substraction process or the like can be performed with high precision.

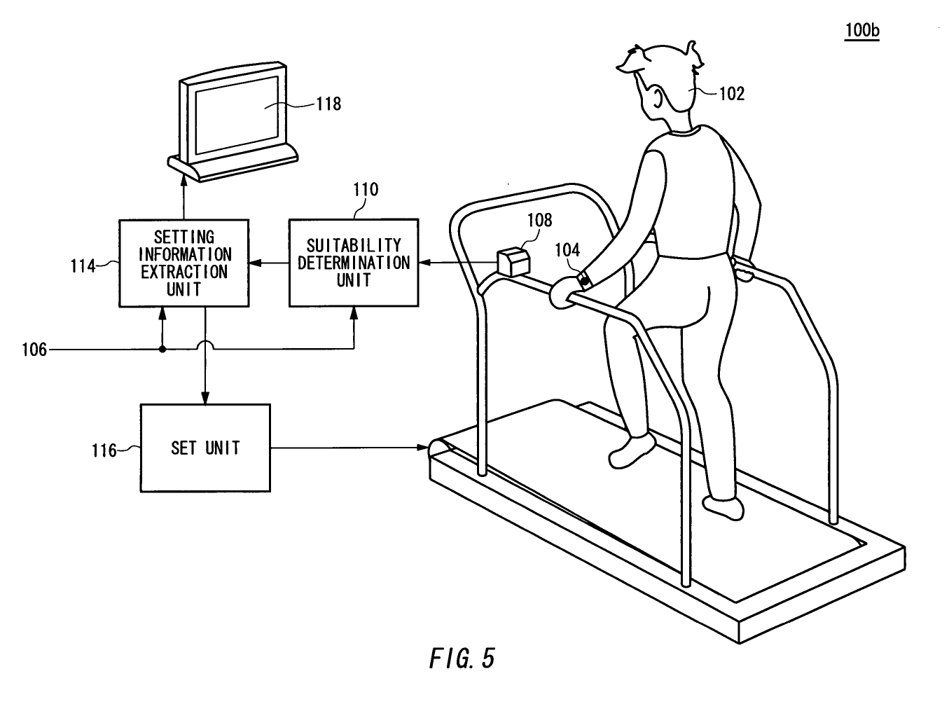

FIG. 5 is the second specific example of the medical support apparatus according to the present embodiment. The medical support apparatus 100 of this example is a training apparatus 100b that supports rehabilitation of the patient 102.

The patient ID acquisition unit 108 obtains the patient ID from the wireless tag 104 of the patient 102 who approached the training apparatus 100b. Since the patient 102 always approaches the training apparatus 100b in a case where the patient 102 undergoes rehabilitation, it is possible to obtain the patient ID of the patient 102 without fail by providing the patient ID acquisition unit 108 in the training apparatus 100b.

When the suitability determination unit 110 confirmed that the patient 102 was to undergo rehabilitation by the aid of the training apparatus 100b, the setting information extraction unit 114 extracts a menu of rehabilitation of the patient 102 from the medical information database 106. The medical information database 106 stores the menu of rehabilitation that was determined as a part of the treatment program of the patient 102 by the doctor. The set unit 116 sets the training apparatus 100b in accordance with the menu of rehabilitation extracted by the setting information extraction unit 114. The display unit 118 displays the menu of rehabilitation thus extracted.

By automatically extracting the menu of rehabilitation of the patient 102, setting the training apparatus 100b and displaying the extracted menu of rehabilitation, it is possible not only to prevent misidentification of patients but also to allow the patient 102 to undergo rehabilitation in accordance with an appropriate menu of rehabilitation.

According to the medical support system 10 of the first embodiment, it is possible to prevent misidentification of patients caused by false belief or oversight of the doctor or nurse, as well as a serious medical error.

(Embodiment 2)

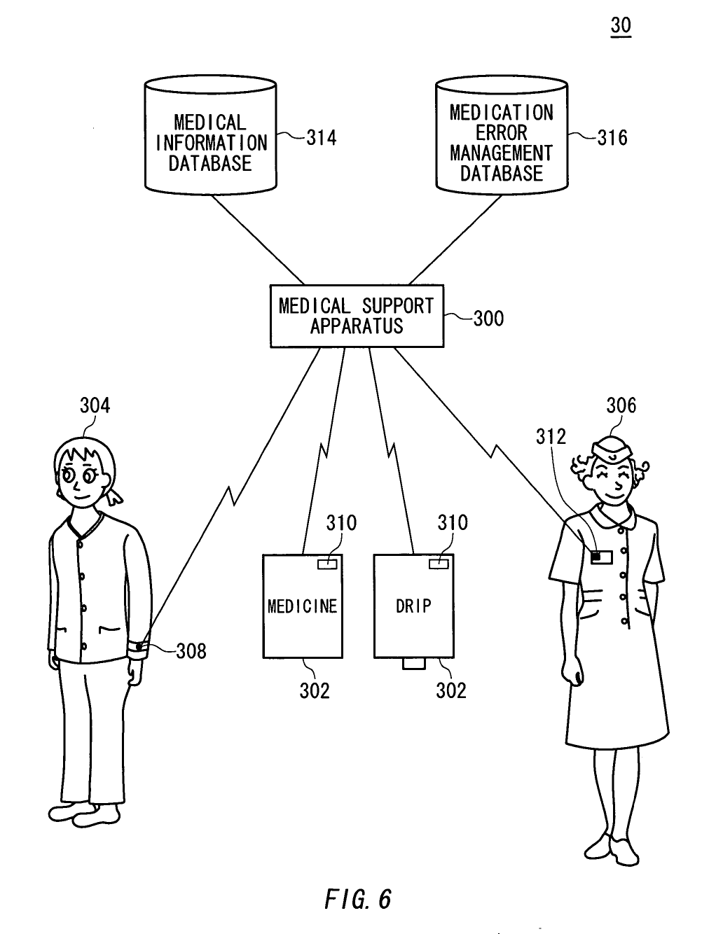

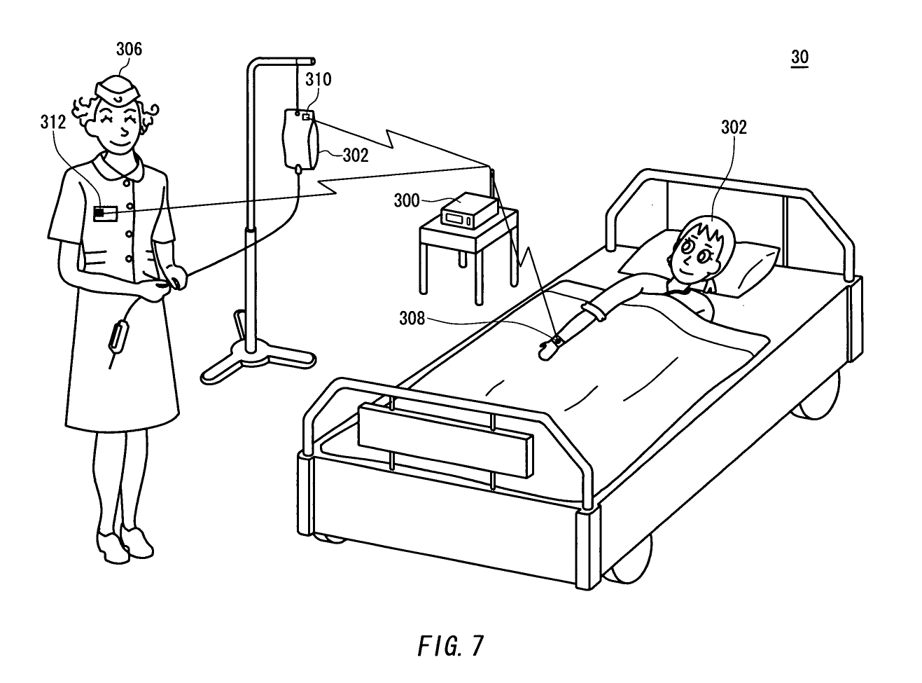

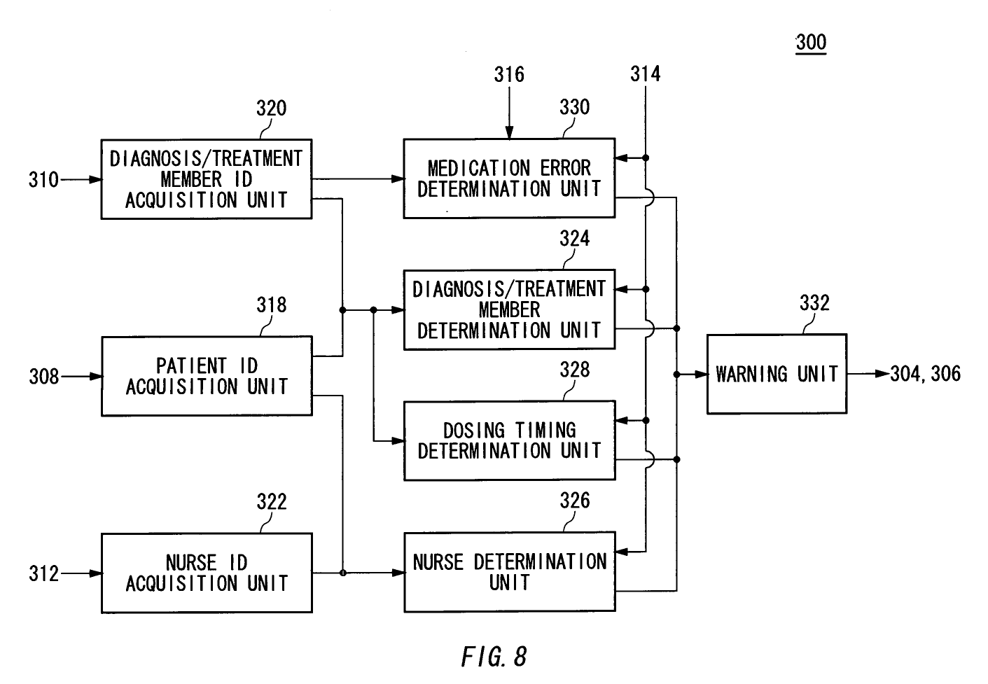

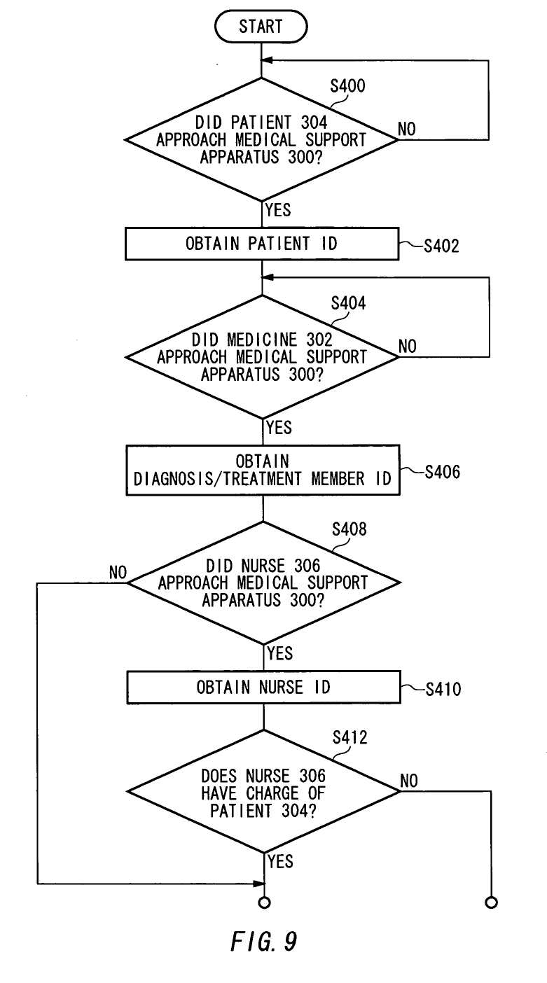

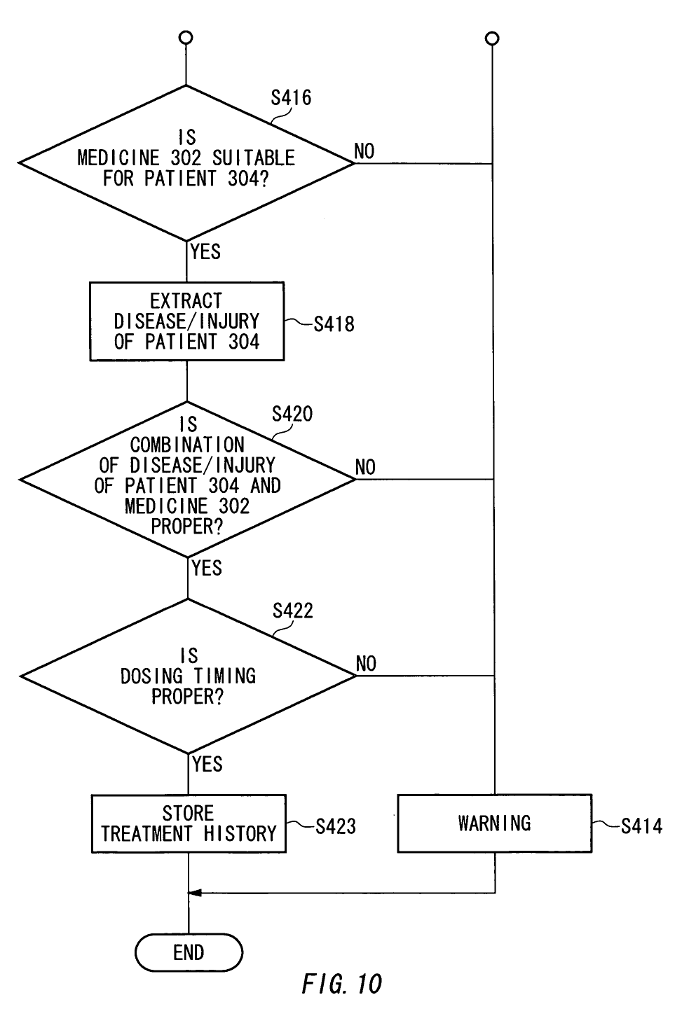

FIGS. 6 and 7 illustrate an exemplary configuration of a medical support system 30 according to the second embodiment of the present invention. The medical support system 30 aims to determine, when a medicine or drops (hereinafter, simply referred to as medicine) 302 held in a bag or the like and a patient 304 approached each other sufficiently, whether or not the medicine 302 is to be dosed to the patient 304, thereby preventing a medication error caused by misidentification of patients, as well as a medical error that may be caused by that medication error. The medical support system 30 also aims to determine, when both the medicine 302 and a nurse 306 approached the patient 304 sufficiently, whether or not the nurse 306 is in charge of the patient 304, i.e., whether or not the nurse 306 is a person who is to dose the medicine 302 to the patient 304, thereby preventing the medication error caused by misidentification of patients by the nurse 306, as well as the medical error that may be caused by that medication error.

The medical support system 30 includes a medical support apparatus 300 that supports a medical care of the patient 304, a patient's wireless tag 308 carried by the patient 304, a diagnosis/treatment member's wireless tag 310 attached to the medicine 302 as an exemplary diagnosis/treatment member, a nurse's wireless tag 312 carried by the nurse 306, a medical information database 314 that stores medical information of patients, and a medication error management database 316 that stores improper combinations of a disease/injury and medicine. The nurse 306 may be a nurse, a doctor or other medical staffs. The diagnosis/treatment member may be an apparatus used in a medical treatment or therapy, a diagnostic apparatus or the like, other than the medicine 302.

The patient's wireless tag 308, the diagnosis/treatment member's wireless tag 310 and the nurse's wireless tag 312 are wireless IC chips, for example. The diagnosis/treatment member's wireless tag 310 is attached to a holder of the medicine 302, such as a bag. The medical support apparatus 300 communicates with the wireless tags 308, 310 and 312, the medical information database 314 and the medication error management database 316 so as to transmit data thereto and receive data therefrom. The medical support apparatus 300 is preferably placed in a region where the medicine 302 is dosed to the patient 304, for example, near the bed of the patient 304.

The patient's wireless tag 308 holds a patient ID for identifying the patient 304 in a memory incorporated therein and transmits the patient ID to the medical support apparatus 300 using a weak radio wave that enables communication with the medical support apparatus 300 only when the wireless tag 308 approached the medical support apparatus 300 sufficiently. For example, the patient's wireless tag 308 transmits the patient ID to the medical support apparatus 300 using a weak radio wave that enables communication with the medical support apparatus 300 only when the wireless tag 308 entered a region within a predetermined distance from the medical support apparatus 300.

The diagnosis/treatment member's wireless tag 310 holds a diagnosis/treatment ID for identifying the medicine 302 in a memory incorporated therein and transmits the diagnosis/treatment member ID to the medical support apparatus 300 using a weak radio wave that enables communication with the medical support apparatus 300 only when the wireless tag 310 approached the medical support apparatus 300 sufficiently. For example, the diagnosis/treatment member's wireless tag 310 transmits the diagnosis/treatment ID to the medical support apparatus 300 using a weak radio wave that enables communication with the medical support apparatus 300 only when the wireless tag 310 entered a region within a predetermined distance from the medical support apparatus 300.

The nurse's wireless tag 312 holds a nurse ID for identifying the nurse 306 in a memory incorporated therein and transmits the nurse ID to the medical support apparatus 300 using a weak radio wave that enables communication with the medical support apparatus 300 only when the wireless tag 312 approached the medical support apparatus 300 sufficiently. For example, the nurse's wireless tag 312 transmits the nurse ID to the medical support apparatus 300 using a weak radio wave that enables communication with the medical support apparatus 300 only when the wireless tag 312 entered a region within a predetermined distance from the medical support apparatus 300. The predetermined distance mentioned above is, for example, a half the distance between adjacent beds.

The medical support apparatus 300 determines that the patient 304, the medicine 302 or the nurse 306 approached it sufficiently from the fact that it obtained the patient ID, the diagnosis/treatment ID or the nurse ID.

The medical information database 314 stores, for the patient 304, information about the disease or injury of the patient 104, information about prescription of medicine 302 for the patient 304, information about a dosing schedule of the medicine 302 to the patient 304, information about patients covered by the nurse 306 who is going to dose the medicine 302 to the patient 304, information about a dosing history containing dates and times at which the medicine 302 was dosed to the patient 304 and the like, so as to correspond to the patient ID of the patient 304. The medical information database 314 allows the medical support apparatus 300 to refer to the contents thereof in response to a request from the medical support apparatus 300. The medication error management database 316 stores combinations of a disease/injury and medicine that should not be dosed to a patient of that disease/injury and allows the medical support apparatus 300 to refer to the contents thereof in response to a request from the medical support apparatus 300.

The medical support apparatus 300 obtains the patient ID from the patient's wireless tag 308 of the patient 304 who is near the medical support apparatus 300, obtains the diagnosis/treatment member ID from the medicine 302 that is near the medical support apparatus 300 and obtains the nurse ID from the nurse's wireless tag 312 of the nurse 306 who is near the medical support apparatus. The medical support apparatus 300 then refers to the medical information of the patient 304 stored in the medical information database 306 based on the patient ID thus obtained.

The medical support apparatus 300 refers to the information about the prescription of medicine 302 for the patient 304 and the information of the dosing schedule of the medicine 302 to the patient 304 and then determines whether or not the medicine 302 identified by the obtained diagnosis/treatment member ID is medicine to be dosed to the patient 304. The medical support apparatus 300 also refers to the information about patients covered by the nurse 306 who is going to dose the medicine 302 to the patient 304 and then determines whether or not the nurse 306 identified by the nurse ID thus obtained is a person who is to dose the medicine 302 to the patient 304. Based on the determination results described above, the medical support apparatus 300 issues a warning to the patient 304 or nurse 306, registers the history of dosing the medicine 302 and performs other processes.

FIG. 3 is an exemplary functional diagram of the medical support apparatus 300 according to the second embodiment. The medical support apparatus 300 includes a patient ID acquisition unit 318 for obtaining the patient ID from the patient's wireless tag 318, a diagnosis/treatment member ID acquisition unit 320 for obtaining the diagnosis/treatment member ID from the diagnosis/treatment member's wireless tag 310, a nurse ID acquisition unit 322 for obtaining the nurse ID from the nurse's wireless tag 312, a diagnosis/treatment member determination unit 324 for determining whether or not the medicine 302 is suitable for the patient 304, a nurse determination unit 326 for determining whether or not the nurse 306 is in charge of the patient 304, a dosing timing determination unit 328 for determining whether or not a dosing timing of the medicine 302 is proper, a medication error determination unit 330 for determining whether or not a combination of the disease/injury of the patient 304 and the medicine 302 is improper, a warning unit 332 for issuing a warning to the patient 304 and the nurse 306 based on the determination results of the diagnosis/treatment member determination unit 324, the nurse determination unit 326, the dosing timing determination unit 328 and the medication error determination unit 330.

FIGS. 4 and 5 are flowcharts of an exemplary operation of the medical support apparatus 300 according to the present embodiment. When the patient 304 approached the medical support apparatus 300 sufficiently (Step S400-Y), the patient ID acquisition unit 318 obtains the patient ID from the patient's wireless tag 308 carried by the patient 304 (Step S402). Moreover, when the medicine 302 approached the medical support apparatus 300 sufficiently (Step S404-Y), the diagnosis/treatment member ID acquisition unit 320 obtains the diagnosis/treatment member ID from the diagnosis/treatment member's wireless tag 310 attached onto the medicine 302 (Step S406).

Moreover, when the nurse 306 approached the medical support apparatus 300 sufficiently (Step S408-Y), the nurse ID acquisition unit 322 obtains the nurse ID from the nurse wireless tag 312 carried by the nurse 306 (Step S410). The nurse determination unit 326 then refers to the medical information database 314 and determines whether or not the nurse 306 identified by the nurse ID obtained by the nurse ID acquisition unit 322 is in charge of the patient 304 identified by the patient ID obtained by the patient ID acquisition unit 328 (Step S422). When the nurse 306 did not approach the medical support apparatus 300 sufficiently (Step S408-N), the acquisition of the nurse ID (Step S410) and the check of the nurse 306 (Step S422) are not performed and the procedure goes to Step S414.

When the nurse determination unit 326 determined that the nurse 306 was not in charge of the patient 304 (Step S422-N), the warning unit 332 issues a warning that notifies the patient 304 and the nurse 306 of that fact (Step S414). On the other hand, when the nurse determination unit 326 determined that the nurse 306 was in charge of the patient 304 (Step S412-Y), the diagnosis/treatment member determination unit 324 refers to the medical information database 314 and determines whether or not the medicine 302 identified by the diagnosis/treatment member ID obtained by the diagnosis/treatment ID acquisition unit 320 is suitable for the patient 304 identified by the patient ID obtained by the patient ID acquisition unit 318 (Step S416).

When the diagnosis/treatment member determination unit 424 determined that the medicine 302 was unsuitable for the patient 304 (Step S416-N), the warning unit 332 issues a warning that notifies the patient 304 and the nurse 306 of that fact (Step S414). On the other hand, the diagnosis/treatment member determination unit 424 determine that the medicine 302 was suitable for the patient 304 (Step S416-Y), the medication error determination unit 330 extracts the disease/injury of the patient 304 identified by the patient ID obtained by patient ID acquisition unit 318, from the medical information database 314 (Step S418). Then, the medication error determination unit 330 refers to the medication error management database 316 and determines whether or not the combination of the disease/injury extracted from the medical information database 314 and the medicine 302 identified by the diagnosis/treatment member ID obtained by the diagnosis/treatment member ID acquisition unit 320 is improper (Step S420).

When the medication error determination unit 330 determined that the combination of the disease/injury of the patient 304 and the medicine 302 was improper (Step S420-N), the warning unit 332 issues a warning that notifies the patient 304 and the nurse of that fact (Step S414). Thus, even if the doctor prescribed the medicine 302 that was improper for the disease/injury of the patient 304, that medication error can be found before the medicine 302 is dosed to the patient 304.

On the other hand, when the medication error determination unit 330 determined that the combination of the disease/injury of the patient 304 and the medicine 302 was proper (Step S420-N), the dosing timing determination unit 328 determines whether or not the dosing timing of the medicine 302 identified by the diagnosis/treatment member ID obtained by the diagnosis/treatment member ID acquisition unit 320 to the patient 304 identified by the patient ID obtained by the patient ID acquisition unit 318, based on the dosing schedule and history stored in the medical information database 314 (Step S422).

When the dosing timing determination unit 328 determined that the dosing timing was improper (Step S422-N), the warning unit 332 issues a warning that notifies the patient 304 and the nurse 306 of that fact (Step S414). On the other hand, when the dosing timing determination unit 328 determined that the dosing timing was proper (Step S422-Y), the medical information database 314 updates the dosing history of the patient 304 and the updated dosing history therein (Step S423). The patient 304 or nurse 306 doses the medicine 302 to the patient 304 in a case where the medical support apparatus 300 issued no warning, or checks the patient 304 or medicine 302 again in a case where the medical support apparatus 300 issued any warning.

According to the medical support system 30 of the present embodiment, it is determined when the medicine 302 and the patient 304 approached each other sufficiently whether or not the medicine 302 is to be dosed to the patient 304, thereby preventing the medication error caused by misidentification of patients, as well as the medical error. Moreover, when both the medicine 302 and the nurse 306 approached the patient 304 sufficiently, it is determined whether or not the nurse 306 is in charge of the patient 304. Thus, the medication error caused by misidentification of patients by the nurse 306, as well as the medical error.

As is apparent from the above, according to a medical support system of the present invention, a medication error caused by misidentification of patients can be prevented and therefore a medical error that may be caused by that medication error can be prevented.

Although the present invention has been described by way of exemplary embodiments, it should be understood that those skilled in the art might make many changes and substitutions without departing from the spirit and the scope of the present invention which is defined only by the appended claims.

What is claimed is:

1. A medical support system for supporting a medical care of a patient, comprising:
a wireless tag carried by the patient;
a medical information database operable to store medical information of the patient; and
a medical support apparatus operable to communicate with said wireless tag and said medical information database, said medical support apparatus comprising:
a patient ID acquisition unit operable to obtain a patient ID for identifying the patient from said wireless tag when the patient approached said medical support apparatus;
a suitability determination unit operable to refer to said medical information database and determine whether or not said medical support apparatus is suitable for the patient identified by the patient ID thus obtained; and
a warning unit operable to issue a warning to the patient when said suitability determination unit determined that said medical support apparatus was unsuitable for the patient.

2. A medical support system as claimed in claim 1, wherein said wireless tag transmits the patient ID to said medical support apparatus using a radio wave that enables communication with said medical support apparatus only when said wireless tag was brought close to said medical support apparatus.

3. A medical support system as claimed in claim 1, wherein said medical support apparatus further includes:
a setting information extraction unit operable to extract setting information related to setting of said medical support apparatus in accordance with the patient from said medical information of the patient stored in said medical information database, when said suitability determination unit determined that said medical support apparatus was suitable for the patient; and
a set unit operable to set said setting information thus extracted in said medical support apparatus.

4. A medical support system as claimed in claim 3, wherein said medical support apparatus is a radiography apparatus, and
said setting information extraction unit extracts a condition of radiography for the patient from said medical information of the patient stored in said medical information database, when said suitability determination unit determined that said medical support apparatus was suitable for the patient.

5. A medical support system as claimed in claim 4, wherein the patient ID acquisition unit is provided on a platform of said radiography apparatus.

6. A medical support system as claimed in claim 1, wherein said medical support apparatus further includes:
a setting information extraction unit operable to extract setting information related to setting of said medical support apparatus in accordance with the patient from said medical information of the patient stored in said medical information database, when said suitability determination unit determined said medical support apparatus was suitable; and
a display unit operable to display said setting information thus extracted.

7. A medical support system as claimed in claim 6, wherein said medical support apparatus is a training apparatus for supporting rehabilitation, and
said setting information extraction unit extracts a menu of rehabilitation of the patient from said medical information of the patient stored in said medical information database, when said suitability determination unit determined that said medical support apparatus was suitable.

8. A medical support apparatus for supporting a medical care of a patient, comprising:
a patient ID acquisition unit operable to obtain a patient ID for identifying the patient from a wireless tag carried by the patient when the patient approached said medical support apparatus;
a suitability determination unit operable to refer to a medical information database that stores medical information of the patient and determine whether or not said medical support apparatus is suitable for the patient identified by the patient ID obtained by the patient ID acquisition unit; and
a warning unit operable to issue a warning to the patient when said suitability determination unit determined that said medical support apparatus was unsuitable for the patient.

9. A medical support system for supporting a medical care of a patient, comprising:
a patient's wireless tag carried by the patient;
a diagnosis/treatment member's wireless tag attached to a diagnosis/treatment member;
a medical information database operable to store medical information of the patient; and
a medical support apparatus operable to communicate with the patient's wireless tag, said diagnosis/treatment member's wireless tag and said medical information database, said medical support apparatus comprising:
a patient ID acquisition unit operable to obtain a patient ID for identifying the patient from the patient's wireless tag when the patient approached said medical support apparatus sufficiently;
a diagnosis/treatment member ID acquisition unit operable to obtain a diagnosis/treatment member ID for identifying said diagnosis/treatment member from said diagnosis/treatment member's wireless tag when said diagnosis/treatment member approached said medical support apparatus sufficiently;
a diagnosis/treatment member determination unit operable to refer to said medical information database and determine whether or not said diagnosis/treatment member identified by said diagnosis/treatment member ID obtained by said diagnosis/treatment member ID acquisition unit is suitable for the patient identified by the patient ID obtained by the patient ID acquisition unit; and
a warning unit operable to issue a warning to the patient when said diagnosis/treatment member determination unit determined that said diagnosis/treatment member was unsuitable.

10. A medical support system as claimed in claim 9, wherein the patient's wireless tag transmits the patient ID to said medical support apparatus using a radio wave that enables communication with said medical support apparatus only when the patient's wireless tag approached said medical support apparatus sufficiently.

11. A medical support system as claimed in claim 9, wherein said diagnosis/treatment member's wireless tag transmits said diagnosis/treatment member ID to said medical support apparatus using a radio wave that enables communication with said medical support apparatus only when said diagnosis/treatment member's wireless tag approached said medical support apparatus sufficiently.

12. A medical support system as claimed in claim 9, further comprising a nurse's wireless tag held by a nurse, wherein said medical support apparatus further includes:
a nurse ID acquisition unit operable to obtain a nurse ID for identifying said nurse from said nurse's wireless tag when said nurse approached said medical support apparatus sufficiently; and
a nurse determination unit operable to refer to said medical information database and determine whether or not said nurse identified by said nurse ID obtained by said nurse ID acquisition unit is in charge of the patient identified by the patient ID obtained by the patient ID acquisition unit, and wherein
said warning unit issues said warning in a case where said nurse is not in charge of the patient.

13. A medical support system as claimed in claim 12, wherein said nurse's wireless tag transmits said nurse ID to said medical support apparatus using a radio waves that enables communication with said medical support apparatus only when said nurse's wireless tag approached said medical support apparatus sufficiently.

14. A medical support system as claimed in claim 9, wherein said diagnosis/treatment member is medicine,
said diagnosis/treatment member's wireless tag is attached to a holder of said medicine, and
said warning unit issues said warning when said diagnosis/treatment member determination unit determined that said medicine was unsuitable for the patient.

15. A medical support system as claimed in claim 14, wherein said medical information database stores a dosing schedule of said medicine to the patient and a dosing history containing dates and times at which said medicine was dosed to the patient to correspond to the patient,
said medical support apparatus further includes a dosing timing determination unit operable to determine whether or not a dosing timing of said medicine identified by said diagnosis/treatment member ID obtained by said diagnosis/treatment member ID acquisition unit to the patient identified by the patient ID obtained by the patient ID acquisition unit, based on said dosing schedule and said dosing history, and
said warning unit issues said warning to the patient when said dosing timing determination unit determined that said dosing timing was improper.

16. A medical support system as claimed in claim 9, further comprising a medication error management database operable to store improper combinations of a disease/injury and said diagnosis/treatment member, wherein
said medical support apparatus further includes a medication error determination unit operable to extract a disease/injury of the patient identified by the patient ID obtained by the patient ID acquisition unit from said medical information database and determine whether or not a combination of said disease/injury thus extracted and said diagnosis/treatment member identified by said diagnosis/treatment member ID obtained by said diagnosis/treatment member ID acquisition unit is improper by referring to said medication error management database, and wherein
said warning unit issues said warning to the patient when said medication error determination unit determined said combination was improper.

17. A medical support apparatus for supporting a medical care of a patient, comprising:
a patient ID acquisition unit operable to obtain a patient ID for identifying the patient from a patient's wireless tag carried by the patient when the patient approached said medical support apparatus sufficiently;
a diagnosis/treatment member ID acquisition unit operable to obtain a diagnosis/treatment member ID for identifying a diagnosis/treatment member from a diagnosis/treatment member's wireless tag attached to said diagnosis/treatment member when said diagnosis/treatment member approached said medical support apparatus sufficiently;
a diagnosis/treatment member determination unit operable to refer to a medical information database that stores medical information of the patient and determine whether or not said diagnosis/treatment member identified by said diagnosis/treatment member ID thus obtained is suitable for the patient identified by the patient ID thus obtained; and
a warning unit operable to issue a warning to the patient when said diagnosis/treatment member determination unit determined that said diagnosis/treatment member was unsuitable for the patient.
